(19) United States
(12) Patent Application Publication
(10) Pub. No.: US 2024/0288296 A1
(43) Pub. Date: Aug. 29, 2024

(54) FITTING AND METHOD OF USING THE FITTING

(71) Applicant: Endress+Hauser Conducta GmbH+Co. KG, Gerlingen (DE)

(72) Inventors: Holger Lippert, Leisnig (DE); Thomas Pfauch, Leipzig (DE); Maik Thormann, Leipzig (DE)

(21) Appl. No.: 18/443,516

(22) Filed: Feb. 16, 2024

(30) Foreign Application Priority Data
Feb. 27, 2023 (DE) 10 2023 104 708.6

(51) Int. Cl. G01F 15/14; G01F 15/12; G01F 15/18

(52) U.S. Cl. CPC G01F 15/14; G01F 15/12; G01F 15/185

(57) ABSTRACT

A fitting for accommodating a sensor includes: an outer housing extending along a first axis including a primary inlet and a primary outlet for medium to flow through the outer housing, a cleaning inflow, and a cleaning outflow; an inner housing extending along the first axis and moveable about the first axis between a measurement position and a service position, the inner housing including a sensor chamber with a secondary inlet and a secondary outlet, wherein the secondary inlet is fluidically connected to the primary inlet, and the secondary outlet is fluidly connected to the primary outlet when the inner housing is in the measurement position, and wherein the cleaning inflow is fluidically connected to the secondary inlet and the cleaning outflow is fluidically connected to the secondary outlet when the inner housing is in the service position; and a sealing unit between the outer housing and the inner housing.

### CROSS-REFERENCE TO RELATED APPLICATION

The present application is related to and claims the priority benefit of German Patent Application No. 10 2023 104 708.6, filed Feb. 27, 2023, the entire contents of which are incorporated herein by reference.

### TECHNICAL FIELD

The present disclosure relates to a fitting and a method of using the fitting.

### BACKGROUND

Fittings, for example, retractable fittings, are widely used in analytical measurement technology and process automation. They are used for removing sensors from the process, and thus from the medium, without interrupting the process and for then reintroducing them into the process. The sensors are fastened in a dip tube and are moved axially by hand or automatically, for example, pneumatically, by means of a drive between a process position (measurement) and a service position (maintenance, calibration, flushing, probe exchange, etc.). These processes take place within a certain period of time, depending on the drift of the measured value or the contamination of the measuring element. The sensors are used to measure one or more physical or chemical process variables.

A great variety of retractable assemblies are offered and marketed by the Endress+Hauser corporate group, for example, under the name “Cleanfit CPA871.” Information about them can be found on the applicant's website, for example, regarding the filing date under: https://www.endress.com/cpa871

Process fittings for sensors (for example, pH sensors) must have special functionalities to enable a sensor to be removed from a running process of a system, for example, for calibration work, etc., without interrupting the process. For this purpose, a fitting generally has a housing in which the sensor is accommodated by a sensor carrier (carriage). The sensor carrier can be moved in these fittings via a drive, manually, pneumatically or electrically, from a measurement position in the process into a second position for service work (calibration on site, rinsing/cleaning) or for removal. A sealing system between the housing and the sensor carrier provides separation from the process chamber. The type of movement of the sensor carrier is dependent on the sealing system.

Sealing rings (O-rings, etc.) are often used, which causes a purely linear movement of the sensor carrier. In the case of linear movements, however, there is the risk that when the fitting is used in a process medium which has a higher viscosity, the sealing rings will become damaged by adhesions of the process medium in the fitting.

A purely rotational movement (rotation/pivoting) would be conceivable, for example, with a plug or ball valve principle. In the case of the plug valve, the sealing effect is brought about by pressing the conical plug against a conical sealing bushing, which results in the required torque being very high. At the same time, the pressure must be continuous.

### SUMMARY

It is therefore an object of the present disclosure to provide a fitting which enables easy, reliable and low-maintenance use.

This object is achieved by a fitting according to the present disclosure.

The fitting according to the present disclosure for accommodating a sensor comprises:
an outer housing which extends along a first axis and has a primary medium inlet and a primary medium outlet for measuring medium to flow through the outer housing, wherein the outer housing moreover has a cleaning inflow channel, a cleaning outflow channel and a fluid channel;
an inner housing which extends along the first axis and can be moved about the first axis between a measurement position and a service position, wherein the inner housing has a sensor chamber with a secondary medium inlet and a secondary medium outlet, wherein the secondary medium inlet is fluidically connected to the primary medium inlet, and the secondary medium outlet is fluidically connected to the primary medium outlet when the inner housing is in the measurement position, wherein the cleaning inflow channel is fluidically connected to the secondary medium inlet, and the cleaning outflow channel is fluidically connected to the secondary medium outlet when the inner housing is in the service position; and
a sealing unit which is disposed between the outer housing and the inner housing, wherein the sealing unit is elastic and has a cavity which is fluidically connected to the fluid channel and is suitable for being pressurized by a fluid with a first fluid pressure in order to press the sealing unit against the outer housing and against the inner housing with a first pressing force so that no measuring medium penetrates into the fitting.

The fitting according to the present disclosure enables a sensor to be used in the fitting easily with little effort. Due to the specific seal, the fitting is more secure than conventional fittings and is therefore also lower maintenance than conventional fittings. In particular, when the position of the fitting is changed (e.g., from the measurement position to the service position or vice versa), great force is not required. Likewise, the manufacturing effort of the fitting is less than with conventional fittings with a plug or ball valve principle since greater tolerances are possible and a cone is not necessary. Furthermore, only minimal surfaces are in contact the media in the fitting according to the present disclosure, which minimizes adhering media residues and therefore a blockage risk. In addition, the sealing pressure in the fitting can be adapted to the process pressure in the measuring medium. The sealing effect or the sealing pressure for moving the valve body can also be reduced, which leads to the minimization of wear of the sealing surface and to the reduction of the necessary drive torque.

According to at least one embodiment of the present disclosure, the sealing unit extends around the first axis, and/or around the primary medium inlet as well as around the primary medium outlet.

According to at least one embodiment of the present disclosure, the sealing unit is integrally formed with the outer housing, for example, by a two-component injection molding method.

According to at least one embodiment of the present disclosure, the outer housing has a first half-part and a second half-part, and the fitting also comprises a clamping ring, wherein the clamping ring is suitable for clamping the sealing unit between the clamping ring and the first half-part and between the clamping ring and the second half-part.

According to at least one embodiment of the present disclosure, the cleaning inflow channel opens with an inflow mouth into the secondary medium inlet when the inner housing is in the service position, and the cleaning outflow channel opens with an outflow mouth into the secondary medium outlet when the inner housing is in the service position, wherein the inflow mouth and the outflow mouth are arranged at a distance from one another along the first axis.

According to at least one embodiment of the present disclosure, the fitting also comprises a securing element which is fastened to the outer housing, wherein the inner housing has a groove running around the first axis and the securing element engages in the groove so that a displacement of the inner housing along the first axis is prevented.

According to at least one embodiment of the present disclosure, the fluid channel has a fluid inlet and a fluid outlet, wherein the fluid outlet opens into the cavity of the sealing unit, wherein the fluid channel has a check valve as to prevent a fluid flow from the fluid outlet to the fluid inlet.

The above-mentioned object is also achieved by a further fitting for accommodating a sensor according to present disclosure. The further fitting according to the present disclosure comprises:
an outer housing which extends along a first axis and has a primary medium inlet and a primary medium outlet for measuring medium to flow through the outer housing, wherein the outer housing moreover has a cleaning inflow channel, a cleaning outflow channel and a fluid channel;
an inner housing which extends along the first axis and can be moved about the first axis between a measurement position and a service position, wherein the inner housing has a sensor chamber with a secondary medium inlet and a secondary medium outlet, wherein the secondary medium inlet is fluidically connected to the primary medium inlet, and the secondary medium outlet is fluidically connected to the primary medium outlet when the inner housing is in the measurement position, wherein the cleaning inflow channel is fluidically connected to the secondary medium inlet, and the cleaning outflow channel is fluidically connected to the secondary medium outlet when the inner housing is in the service position, wherein a gap having a predetermined gap width is formed between the inner housing and the outer housing; and
a sealing unit which is arranged in the gap and has a predetermined sealing thickness, wherein the sealing thickness is greater than the gap width so that the sealing unit is pressed against the outer housing and against the inner housing with a first pressing force, wherein the sealing unit is elastic and has a cavity which is fluidically connected to the fluid channel and is suitable for being pressurized by a fluid with a second fluid pressure so that the sealing unit is pressed against the outer housing and against the inner housing with a second pressing force, wherein the second pressing force is less than the first contact pressure.

The above-mentioned object is also achieved by a method of using a fitting according to the present disclosure. The method according to the present disclosure comprises at least the following steps:
providing a fitting according to the present disclosure, wherein the inner housing is in the measurement position and the sealing unit is pressurized with a first fluid pressure by a fluid so that the sealing unit is pressed against the outer housing and against the inner housing with a first pressing force so that no measuring medium penetrates into the fitting;
pressurizing the sealing unit with a third fluid pressure by a fluid so that the sealing unit is pressed against the outer housing and against the inner housing with a third pressing force;
moving the inner housing from the measurement position into the service position; and
pressurizing the sealing unit with the first fluid pressure by the fluid so that the sealing unit is pressed against the outer housing and against the inner housing with the first pressing force, and no measuring medium penetrates into the fitting.

The above-mentioned object is also achieved by a further method of using a fitting according to the present disclosure. The further method according to the present disclosure comprises at least the following steps:
providing a fitting according to the present disclosure, wherein the inner housing is in the measurement position and the sealing unit is pressed against the outer housing and against the inner housing with a first pressing force so that no measuring medium penetrates into the fitting;
pressurizing the sealing unit with a third fluid pressure by a fluid so that the sealing unit is pressed against the outer housing and against the inner housing with a third pressing force;
moving the inner housing from the measurement position into the service position; and
releasing the pressurization of the sealing unit with the third fluid pressure so that the sealing unit is pressed with the first pressing force against the outer housing and against the inner housing so that no measuring medium penetrates into the fitting.

### BRIEF DESCRIPTION OF THE DRAWINGS

The present disclosure is explained in more detail with respect to the following figures, in which:

FIG. 1 shows a perspective, sectional view of an exemplary fitting according to the present disclosure in measurement position with a sensor;

FIG. 2 shows a perspective, sectional view of the fitting of FIG. 1 in service position;

FIG. 3 shows a sectional view of the fitting of FIG. 1 in service position; and

FIG. 4 shows a perspective view of the fitting of FIG. 1.

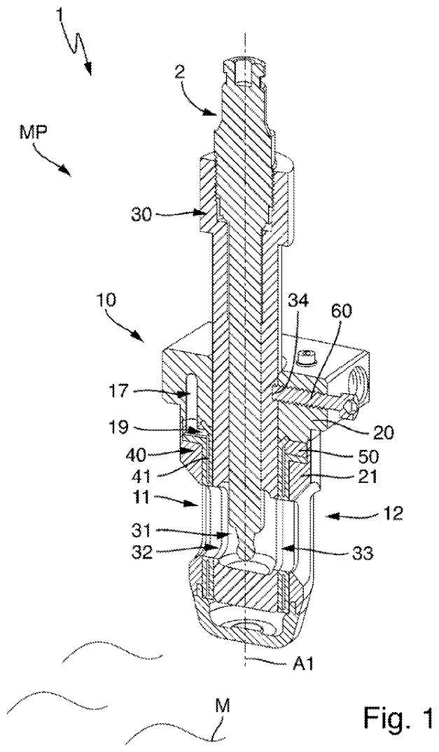

FIG. 1 shows an exemplary embodiment of the fitting 1 according to the present disclosure with a sensor 2 accommodated in the fitting 1. The sensor 2 is, for example, a pH sensor.

The fitting 1 has an outer housing 10, an inner housing 30 as well as a sealing unit 40, and is suitable for receiving a sensor 2.

### DETAILED DESCRIPTION

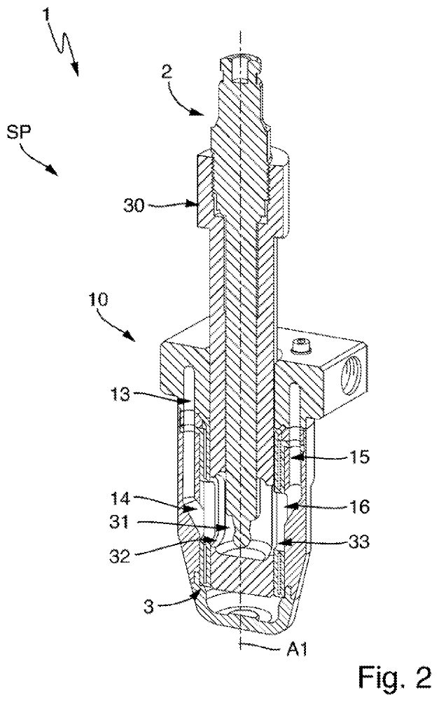

The outer housing 10 extends along a first axis A1 and has a primary medium inlet 11 as well as a primary medium outlet 12. The primary medium inlet 11 and the primary medium outlet 12 enable measuring medium M to flow through the outer housing 10. The outer housing 10 furthermore has a cleaning inflow channel 13, a cleaning outflow channel 15 as well as a fluid channel 17 (FIGS. 1 and 2). The cleaning inflow channel 13 has an inflow mouth 14, and the cleaning outflow channel 15 has an outflow mouth 16 (FIG. 2). The outer housing 10 is preferably configured to be fastened to a container (not shown). The container is, for example, a process container with an opening designed for receiving the fitting 1. The outer housing 10 has a section which is suitable to come into contact with the measurement medium.

The inner housing 30 extends along the first axis A1 and is mounted in the outer housing 10. The inner housing 30 is movable about the first axis A1 between a measurement position MP and a service position SP. The inner housing 30 is, for example, either manually moved via a lever (not shown), or by an electrical or fluidic drive (not shown) between the measurement position MP and the service position SP. The movement of the inner housing 30 between the positions SP, MP is performed, for example, by hand, mechanically or pneumatically. In the measurement position MP, a measuring medium M is able to flow through the fitting 1 and in particular the sensor chamber 31 in which the sensor 2 is arranged. In the service position SP, the sensor chamber 31 is suitable for a cleaning fluid and/or a calibration fluid to flow through in order to clean the fitting 1 and the sensor 2 or, for example, to calibrate the sensor 2. The inner housing 30 preferably extends partially out of the process container when the fitting 1 is arranged in the opening of the process container. The inner housing 30 preferably has a threaded interface as to fasten the sensor 2 in the inner housing 30. Of course, other form-fitting connections, such as bayonet connections are also possible to fasten the sensor 2 in the inner housing 30. According to an embodiment (not shown), the inner housing 30 optionally also has a sensor carrier or sensor carriage arranged in the inner housing 30, in which the sensor is mounted. The sensor carriage allows additional safety functions to be implemented, for example, protection against glass breakage.

The inner housing 30 has a sensor chamber 31 with a secondary medium inlet 32 as well as a secondary medium outlet 33. The secondary medium inlet 32 is fluidically connected to the primary medium inlet 11 of the outer housing 10, and the secondary medium outlet 33 is fluidically connected to the primary medium outlet 12 of the outer housing 10 when the inner housing 30 is in the measurement position MP (FIG. 1).

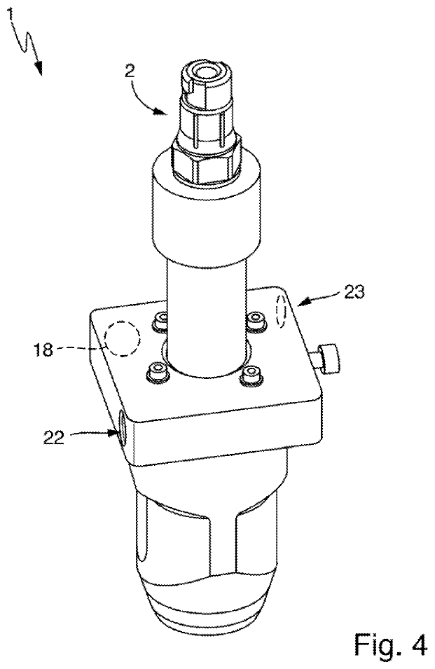

The cleaning inflow channel 13 of the outer housing 10 has a cleaning inlet 22 and an inflow mouth 14. The cleaning inlet 22 makes it possible to feed a cleaning or calibration fluid into the cleaning inflow channel 13 (see FIG. 2 and FIG. 4). Preferably, the cleaning inlet 22 has, for example, threaded interface, for example, to fasten a hose to the outer housing 10. The cleaning inflow channel 13 opens with the inflow mouth 14 into the secondary medium inlet 32 when the inner housing 30 is in the service position SP (FIG. 2). The cleaning inflow channel 13 is therefore fluidically connected to the sensor chamber 31.

The cleaning outflow channel 15 of the outer housing 10 has a cleaning outlet 23 and a outflow mouth 16. The cleaning outlet 23 makes it possible to evacuate a cleaning or calibration fluid from the cleaning outflow channel 15 (see FIGS. 2 and 4). Preferably, the cleaning outlet 23 has a thread, for example, in order for example, to fasten a hose to the outer housing 10. The cleaning outflow channel 15 opens with the outflow mouth 16 into the secondary medium outlet 33 when the inner housing 30 is in the service position SP (FIG. 2). The cleaning outflow channel 15 is therefore fluidically connected to the sensor chamber 31.

The inflow mouth 14 and the outflow mouth 16 of the outer housing 10 are preferably arranged at a distance from one another along the first axis A1. This enables the advantage that the cleaning fluid, for example, air, is better conducted out of the sensor chamber 31.

According to an embodiment, the sealing unit 40 is disposed between the outer housing 10 and the inner housing 30. The sealing unit 40 is elastic and has a cavity 41 which is fluidically connected to the fluid channel 17 (FIG. 1). The fluid outlet 19 of the fluid channel 17 opens into the cavity 41. The cavity 41 is suitable for being pressurized with a fluid via the fluid channel 17 with a first fluid pressure P1 in order to press the sealing unit 40 against the outer housing 10 and against the inner housing 30 with a first pressing force F1. This ensures that no measuring medium M penetrates into the fitting 1. The fluid channel 17 preferably has a non-return valve configured to prevent a fluid flow from the fluid outlet 19 to the fluid inlet 18. The first fluid pressure P1 is preferably selected such that it is greater than a pressure of the measuring medium M. The first fluid pressure P1 is preferably selected depending on the pressure of the measuring medium M.

When the sealing unit 40 is pressurized with the fluid with the first fluid pressure P1, the sealing unit 40 is in a sealing state.

When the sealing unit 40 is pressurized with the fluid with a second fluid pressure P2 which is preferably greater than or equal to the pressure of the measuring medium M, the sealing unit 40 is in a relaxed state.

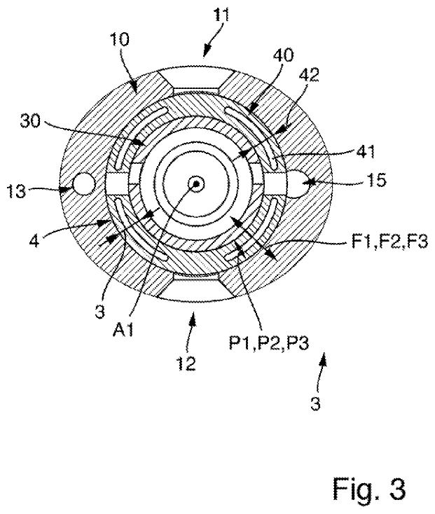

The sealing unit 40 preferably runs around the first axis A1 (see FIG. 3) and/or around the primary medium inlet 11 and around the primary medium outlet 12 (see FIGS. 1 and 3).

According to the embodiment of the fitting 1 shown in FIGS. 1-4, the outer housing 10 has a first half-part 20 and a second half-part 21.

The fitting 1 comprises a clamping ring 50. The clamping ring 50 is suitable for clamping the sealing unit 40 between the clamping ring 50 and the first half-part 20 and between the clamping ring 50 and the second half-part 21 (see FIGS. 1 and 2).

According to a further embodiment (not shown), the sealing unit 40 is integrally formed with the outer housing 10, for example, by a two-component injection molding method.

According to at least one embodiment of the fitting 1 which is compatible with all possible mentioned embodiments, the fitting 1 furthermore comprises a securing element 60 which is fastened to the outer housing 10. The inner housing 30 furthermore includes a groove 34 running around the first axis A1. The securing element 60 is arranged in the outer housing 10 in such a way that the securing element 60 engages in the groove so that a displacement of the inner housing 30 along the first axis A1 is prevented. The securing element 60 is, for example, a clamping screw, a split pin, or a similar component.

A gap 3 having a predetermined (e.g., preset, selected) gap width 4 is formed (e.g., created, defined) between the inner housing 30 and the outer housing 10. The sealing unit 40 is disposed in the gap 3 and has a predetermined (e.g., preset, selected) sealing thickness 42 (see FIG. 3).

According to an alternative embodiment of the sealing unit 40, the sealing unit 40 has a predetermined sealing thickness 42. The sealing thickness 42 is greater than the gap width 4 so that the sealing unit 40 is pressed against the outer housing 10 and against the inner housing 30 with a first pressing force F1. Thanks to the first pressing force F1, the sealing unit 40 is in the pressed state.

According to such an embodiment, the sealing unit 40 is suitable for entering the relaxed state by pressurizing the cavity 41 with a fluid which has a second fluid pressure P2 which is less than or equal to the pressure of the measuring medium M so that the sealing unit 40 is pressed against the outer housing 10 and against the inner housing 30 with a second contact pressure F2, wherein the second contact pressure is less than the first contact pressure.

Methods of using the fitting 1 are discussed below. According to an embodiment of the method, the first above-described embodiment of the sealing unit 40 may be used.

According to a first step, the method comprises providing the above-described fitting 1. The inner housing 30 is in the measuring position MP, and the sealing unit 40 is pressurized with a first fluid pressure P1 by the fluid so that the sealing unit 40 is pressed against the outer housing 10 and against the inner housing 3 with the first pressing force F1, and no measuring medium M penetrates into the fitting 1.

This is followed by a step of pressurizing the sealing unit 40 with a third fluid pressure P3 by a fluid so that the sealing unit 40 is pressed against the outer housing 10 and against the inner housing 30 with a third pressing force F3. The third pressing force F3 is lower than the first pressing force F1. The sealing unit 40 is therefore in the relaxed state.

This is followed by a step of moving the inner housing 30 from the measurement position MP (FIG. 1) into the service position SP (FIG. 2).

Next comes a step of pressurizing the sealing unit 40 with the first fluid pressure P1 by the fluid so that the sealing unit 40 is pressed against the outer housing 10 and against the inner housing 30 with the first pressing force F1. The first fluid pressure P1 is preferably greater than or equal to the pressure of the measuring medium M so that no measuring medium M penetrates into the fitting 1.

According to a further embodiment of the method, the second above-described embodiment of the sealing unit 40 may be used. As explained above, in such an embodiment, the sealing unit 40 has a sealing thickness 42 which is greater than the gap width 4 of the gap 3 between the inner housing 30 and the outer housing 10. Since the sealing unit 40 is elastic, the sealing unit 40 is therefore pressed against the outer housing 10 and against the inner housing 30 even with a first pressing force F1 without pressurizing the cavity 41 with a fluid. Here too, the first pressing force F1 is selected such that a medium pressure is resisted, and no measuring medium M penetrates into the fitting 1.

In another step, the sealing unit 40 is pressurized with a third fluid pressure P3 by a fluid so that the sealing unit 40 is pressed against the outer housing 10 and against the inner housing 30 with a third pressing force F3. The third fluid pressure P3 is preferably equal to the pressure of the measuring medium M. In any case, the third pressing force F3 is lower than the first pressing force F1. This makes it possible for the inner housing 30 to be rotatable relative to the outer housing 10 with a small amount of force. In this step, pressurizing the sealing unit 40 with a fluid preferably means pressurizing it with a vacuum. The sealing unit 40 is therefore in the relaxed state.

This is followed by a step of moving the inner housing 30 from the measurement position MP into the service position SP takes place.

Then comes a step of releasing the pressurization of the sealing unit 40 with the third fluid pressure P3 so that the sealing unit 40 is pressed with the first pressing force F1 against the outer housing 10 and against the inner housing 30, and no measuring medium M penetrates into the fitting 1. The sealing unit 40 is therefore in the pressed state.

Claimed is:

1. A fitting for receiving a sensor, the fitting comprising:
an outer housing which extends along a first axis and includes a primary medium inlet and a primary medium outlet, each configured to enable measuring medium to flow through the outer housing, wherein the outer housing further includes a cleaning inflow channel, a cleaning outflow channel, and a fluid channel;
an inner housing which extends along the first axis and is configured to be moveable about the first axis between a measurement position and a service position, wherein the inner housing includes a sensor chamber having a secondary medium inlet and a secondary medium outlet,
wherein the secondary medium inlet is fluidically connected to the primary medium inlet, and the secondary medium outlet is fluidly connected to the primary medium outlet when the inner housing is in the measurement position, and
wherein the cleaning inflow channel is fluidically connected to the secondary medium inlet and the cleaning outflow channel is fluidically connected to the secondary medium outlet when the inner housing is in the service position; and
a sealing unit disposed between the outer housing and the inner housing, wherein the sealing unit is elastic and includes a cavity therein fluidically connected to the fluid channel and operable to be pressurized by a fluid having a first fluid pressure so as to press the sealing unit against the outer housing and against the inner housing with a first pressing force such that no measuring medium penetrates into the fitting.

2. The fitting according to claim 1, wherein the sealing unit extends around the first axis and/or around the primary medium inlet and the primary medium outlet.

3. The fitting according to claim 1, wherein the sealing unit is integrally formed with the outer housing.

4. The fitting according to claim 1, wherein the sealing unit is integrally formed with the outer housing by a two-component injection molding method.

5. The fitting according to claim 1, further comprising a clamping ring,
wherein the outer housing comprises a first half-part and a second half-part, and wherein the clamping ring is configured to clamp the sealing unit between the clamping ring and the first half-part and between the clamping ring and the second half-part.

6. The fitting according to claim 1, wherein the cleaning inflow channel opens via an inflow mouth into the secondary medium inlet when the inner housing is in the service position, and wherein the cleaning outflow channel opens via a outflow mouth into the secondary medium outlet when the inner housing is in the service position,
wherein the inflow mouth and the outflow mouth are arranged at a distance from one another along the first axis.

7. The fitting according to claim 1, further comprising a securing element, which is fastened to the outer housing,
wherein the inner housing includes a groove extending around the first axis, and wherein the securing element engages in the groove such that a displacement of the inner housing along the first axis is prevented.

8. The fitting according to claim 1, wherein the fluid channel includes a fluid inlet and a fluid outlet, wherein the fluid outlet opens into the cavity of the sealing unit, wherein the fluid channel includes a check valve configured to prevent a fluid flow from the fluid outlet to the fluid inlet.

9. A fitting for receiving a sensor, the fitting comprising:
an outer housing which extends along a first axis and includes a primary medium inlet and a primary medium outlet for measurement medium to flow through the outer housing,
wherein the outer housing includes a cleaning inflow channel, a cleaning outflow channel, and a fluid channel;
an inner housing which extends along the first axis and is moveable about the first axis between a measurement position and a service position,
wherein the inner housing includes a sensor chamber with a secondary medium inlet and a secondary medium outlet,
wherein the secondary medium inlet is fluidically connected to the primary medium inlet, and the secondary medium outlet is fluidly connected to the primary medium outlet when the inner housing is in the measurement position,
wherein the cleaning inflow channel is fluidically connected to the secondary medium inlet, and the cleaning outflow channel is fluidically connected to the secondary medium outlet when the inner housing is in the service position,
wherein a gap of a preset gap width is formed between the inner housing and the outer housing; and
a sealing unit arranged in the gap and having a preset sealing thickness, wherein the sealing thickness is greater than the gap width such that the sealing unit is pressed against the outer housing and against the inner housing with a first pressing force,
wherein the sealing unit is elastic and includes a cavity therein, which is fluidically connected to the fluid channel and is configured to be pressurized by a fluid with a second fluid pressure such that the sealing unit is pressed against the outer housing and against the inner housing with a second pressing force, wherein the second pressing force is less than the first pressing force.

10. A method of using a fitting in a process having a measuring medium, the method comprising:
providing a fitting according to claim 1,
wherein the inner housing is in the measurement position, and the sealing unit is pressurized with a first fluid pressure by a fluid such that the sealing unit is pressed against the outer housing and against the inner housing by a first pressing force such that no measuring medium penetrates into the fitting;
pressurizing the sealing unit with a third fluid pressure by a fluid such that the sealing unit is pressed against the outer housing and against the inner housing with a third pressing force;
moving the inner housing from the measurement position into the service position; and
pressurizing the sealing unit with the first fluid pressure by the fluid such that the sealing unit is pressed against the outer housing and against the inner housing with the first pressing force and such that no measuring medium penetrates into the fitting.

11. A method of using a fitting in a process having a measuring medium, the method comprising:
providing a fitting according to claim 8,
wherein the inner housing is in the measurement position, and the sealing unit is pressed against the outer housing and against the inner housing with a first pressing force such that no measuring medium penetrates into the fitting;
pressurizing the sealing unit at a third fluid pressure by a fluid such that the sealing unit is pressed against the outer housing and against the inner housing with a third pressing force;
moving the inner housing from the measurement position into the service position; and
releasing the pressurization of the sealing unit at the third fluid pressure such that the sealing unit is pressed with the first pressing force against the outer housing and against the inner housing such that no measuring medium penetrates into the fitting.
